(19) United States
(12) Patent Application Publication
(10) Pub. No.: US 2023/0106414 A1
(43) Pub. Date: Apr. 6, 2023

(54) MANAGING UPDATES TO HOSTS IN A COMPUTING ENVIRONMENT BASED ON FAULT DOMAIN HOST GROUPS

(71) Applicant: VMware, Inc., Palo Alto, CA (US)

(72) Inventors: Naga Ullas Vankayala Harinathagupta, San Jose, CA (US); Jonathan Prince Limhengco, San Francisco, CA (US); Yuedong Mu, San Jose, CA (US)

(21) Appl. No.: 17/495,635

(22) Filed: Oct. 6, 2021

(51) Int. Cl. G06F 9/455; G06F 9/50

(52) U.S. Cl. CPC G06F 9/45558; G06F 9/5077; G06F 9/5055; G06F 9/5038; G06F 2009/45579; G06F 2009/4557; G06F 2209/5021; G06F 2209/501

(57) ABSTRACT

Described herein are systems, methods, and software to manage the update to hosts in a computing environment. In one implementation, a method of operating an update service includes identifying a request to update a plurality of hosts and identifying host groups for the plurality of hosts. The method further includes prioritizing the host groups for the update and selecting a host group to be updated based on the prioritization. Once the host group is selected, the method also provides for identifying hosts to be updated for the host group based on resource scheduling information for the workloads in the host group. Once the group is updated, the method further includes repeating the update process for other host groups until all the host groups are updated.

### BACKGROUND

In computing environments, host computing systems or hosts are used to provide a platform for virtual machines, containers, or other virtualized endpoints (workloads) to efficiently provide computing resources to multiple virtualized endpoints. Software and/or firmware on the hosts is used to abstract the physical components of the host and provide the abstracted physical components to the workloads. The abstracted components may comprise processing resources, memory resources, storage resources, networking resources, or some other resource.

In some implementations, the software and/or firmware providing the platform for the workloads may require an update. However, the updates may cause downtime or affect other operations in association with the workloads. These issues can be compounded as a data center expands with additional host computing systems networking and other operations. Additional issues may arise when a computing environment is distributed across multiple computing sites and physical data centers.

### SUMMARY

The technology disclosed herein manages the updates to hosts in a computing environment based on fault domain host groups. In one implementation, a method includes identifying a request to update a plurality of hosts in a computing environment and, in response to the request, identifying host groups in a computing environment to be updated, wherein each of the host groups comprises one or more hosts of the plurality of hosts. The method further includes prioritizing the host groups for updates and selecting a group in the host groups for updating based on the prioritization of the host groups. Once selected, the method includes selecting one or more hosts from the host group to be updated based at least on resource scheduling, updating the one or more hosts, and removing the one or more hosts from the host group to be updated. After removing the one or more hosts, the method also provides for repeating the selection of one or more hosts so long as at least one host remains in the host group to be updated.

Once the hosts are updated from the group, the method also includes selecting a next host group in the host groups based on the prioritization so long as another host group has not been updated and repeating the update operations for the hosts in the selected host group. If no host group remains that has not been updated, the update process to the computing environment is complete.

### BRIEF DESCRIPTION OF THE DRAWINGS

FIG. 1 illustrates a computing environment to manage the update of hosts according to an implementation.

FIG. 2 illustrates an operation of an update service to manage the update of hosts according to an implementation.

FIG. 3 illustrates a timing diagram for updating multiple host groups according to an implementation.

FIG. 4 illustrates an operational scenario of updating hosts within a host group according to an implementation.

FIG. 5 illustrates a computing system with an update service to manage the update of hosts in a computing environment according to an implementation.

### DETAILED DESCRIPTION

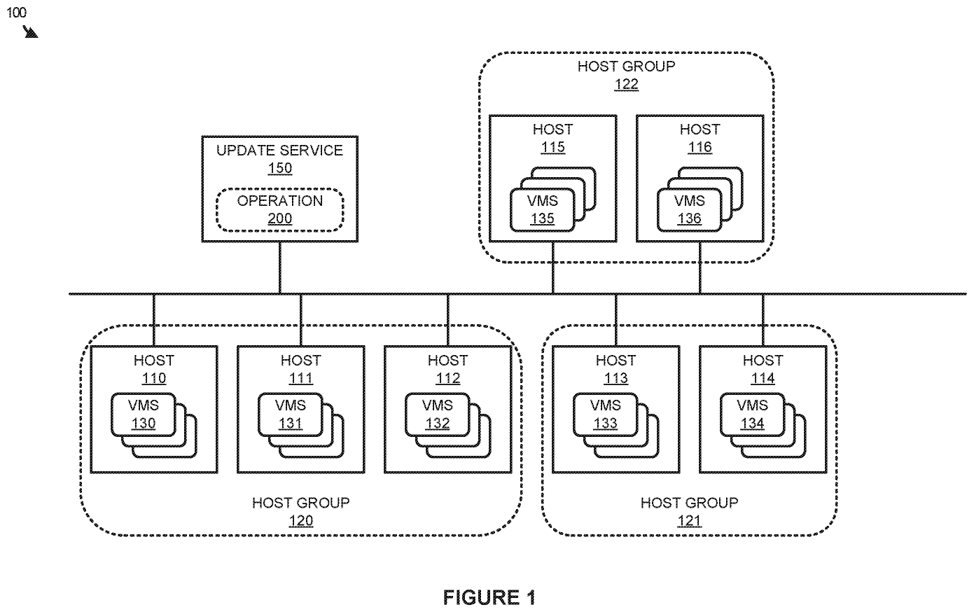

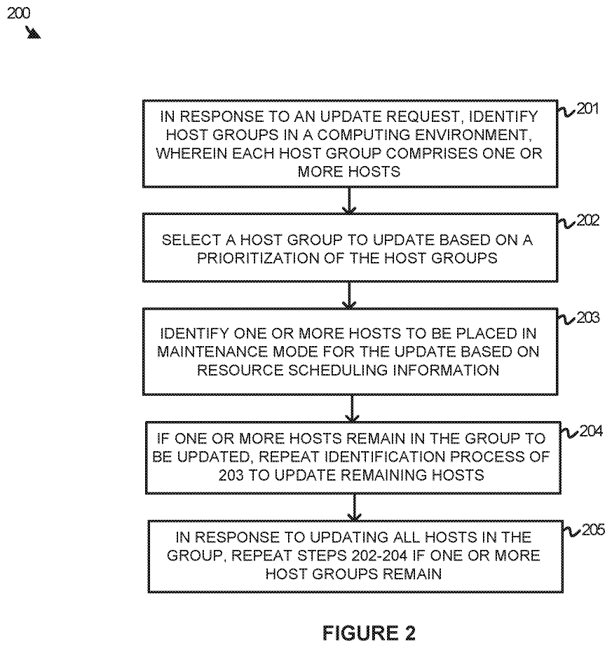

FIG. 1 illustrates a computing environment 100 to manage the update of hosts according to an implementation. Computing environment 100 includes hosts 110-115 that reside host groups 120-122. Hosts 110-116 provide a platform for virtual machines (VMs) 130-136. While virtual machines are shown and described herein throughout, other types of workloads, such as namespace containers, may substituted without significantly impacting the described systems and methods, and with similar beneficial result. A virtual machine is generally understood to include a logical partition of physical computer resources, an operating system, and application software running on that partition, whereas a namespace container, such as a Docker container, also referred to as “operating system-level virtualization,” is an execution space logically partitioned by the operating system running on a physical computer or virtual machine. Computing environment 100 further includes update service 150 that is used to provide operation 200 that is further described below with respect to FIG. 2. Update service 150 may execute on one or more physical computing systems and may be in the same data center as one or more of the hosts or in a separate physical location.

In computing environment 100, hosts 110-116 provide a platform for virtual machines 130-136, wherein hosts 110-116 may abstract the physical components of the computers and provide the abstracted components to virtual machines 130-136. During the execution of virtual machines 130-136, update service 150 may identify a request to update the platform for the virtual machines from a first version to a second version. The update may be used to provide additional functionality, fix issues in association with the platform, or provide some other operation. For example, the update may be used to increase the efficiency in association with providing resources to the virtual machines.

Hosts 110-116 may be in the same computing site or data center or may be distributed across multiple computing sites or data centers. In at least one implementation, host groups 120-122 may represent fault domains or availability zones, wherein fault domains are a set of hardware components that share a single point of failure. For example, a computing environment may be configured to be rack tolerant, such that servers and data are distributed across multiple racks, may be chassis tolerant, such that data is distributed across multiple chassis, or may be computing site tolerant, wherein multiple copies of data are distributed across multiple computing sites.

Here, when an update request is identified by update service 150, update service 150 identifies the host groups 120-122 in computing environment 100. In some implementations, the host groups may be identified by fault domain identifiers associated with each of the hosts. For example, hosts 110-112 may have a different fault domain identifier than hosts 113-116. Once the host groups are identified, update service 150 may identify priorities associated with each of the host groups and initiate the updates to the host groups based on the prioritization. In at least one example, update service 150 may identify the number of hosts that are required to be updated in each of the host groups and prioritize the groups for updating based on the number of hosts. Host groups with a smaller number of hosts to be updated may be prioritized over host groups with a larger number of hosts to be updated. After the host groups are identified, update service 150 may identify the host group with the highest priority and initiate an update to the hosts in the host group.

In some examples, update service 150 may select one or more hosts in the host group to update based on one or more factors, wherein the factors may include information from a resource scheduling service, a quality of service required for the virtual machines operating in the computing environment, or some other factor. For example, update service 150 may identify host group 120 to be updated and may select a host or hosts from hosts 110-112 to be updated based on one or more factors. Once the host or hosts are selected and updated, update service 150 may determine whether one or more additional hosts in the host group still require an update. When additional hosts require an update, update service 150 may use the one or more factors to select additional hosts and repeat the update process until all hosts within a host group are updated. Update service 150 may then select another host group to update and repeat the update process until all host groups are updated. In at least one implementation, an administrator may select one or more of the host groups to update without updating other host groups. For example, an administrator of computing environment 100 may select host group 120

FIG. 2 illustrates an operation 200 of an update service to manage the update of hosts according to an implementation. The steps of operation 200 are referenced parenthetically in the paragraphs that follow with reference to systems and elements of computing environment 100 of FIG. 1.

In operation 200, update service 150 identifies a request to update hosts in computing environment 100. In response to the request, update service 150 identifies (201) host groups in the computing environment to be updated, wherein each of the hosts groups comprises one or more hosts. In some implementations, the host groups may represent fault domains, wherein each of the hosts may be assigned an identifier associated with a fault domain. The fault domains may be rack based, chassis based, or data center based. For example, each host group of host groups 120-122 may represent a different data center.

Once the host groups are identified, operation 200 further prioritizes the host groups for updates based at least on the quantity of hosts not updated in each of the host groups and selects (202) a host group to update based on the prioritization. In some implementations, update service 150 may prioritize the host groups with the smallest number of hosts to be updated. For example, host group 120 may include three hosts to be updated, while host group 121 includes two hosts to be updated. Thus, host group 121 may be prioritized over host group 120 for updating. In some examples, in addition to or in place of using the number of hosts to be updated to prioritize the host groups, update service 150 may prioritize the host groups based on an administrator configuration, wherein an administrator may indicate a primary host group (primary site host group) and one or more secondary host groups (secondary site host groups). For example, an administrator may define host group 121 as a primary host group and host groups 120 and 122 as secondary and third host groups. Accordingly, if host group 121 included one or more hosts that require an update, the one or more hosts in host group 121 may be updated prior to the hosts in the other host groups.

Once the host group is selected, update service 150 further, for the selected host group, selects (203) one or more hosts from the host group to be updated or placed in maintenance mode based at least on resource scheduling information. In some examples, update service 150 may communicate with a resource scheduling service that manages the allocation of resources to the virtual machines in computing environment 100. The resource scheduling service may provide identifiers for the one or more hosts to be placed in maintenance mode for the update. The one or more hosts may be selected based on virtual machines being transferred to other hosts in the cluster, a lack of virtual machines executing on the host, or some other selection mechanism, such that the hosts are no longer required in the computing environment. In at least one example, the resource scheduling information may be used in conjunction with a service level agreement or quality of service associated with the cluster in the computing environment. The minimum quality of service may indicate a minimum number of virtual machines executing, processing or memory resources for the virtual machines, or some other quality of service associated with the cluster. As an example, when updating host group 120, a minimum quality of service may require at least two hosts of hosts 110-112 to provide a platform for the virtual machine. The virtual machines from the host to be updated may be powered down, migrated to another host, or provided some other operation in association with the resource scheduling service. The host may then be updated by update service 150.

After the one or more hosts are updated, the one or more hosts are removed from the list of hosts to be updated for the host group. Update service 150 then determines whether at least one host remains in the host group to be updated. If at least one host remains in the group to be updated, update service 150 repeats (204) step 203 as required until all the hosts in the host group are updated. Referring to an example in computing environment 100, when updating host group 120, a resource scheduling service may indicate that host 110 can be updated. After updating host 110, host 110 may be removed from the list of hosts to be updated and the resource scheduling service may identify one or more of hosts 111-112 to update. The process is repeated until each of the hosts in host group 120 is updated.

Once all the host are updated, operation 200 further repeats (205) steps 202-204 until all the host groups are updated. For example, if host group 120 is initially selected for updating based on the prioritization, update service 120 may select a host group from host groups 121-122 based on the prioritization. The prioritization may be based on the number of hosts requiring the update in the host groups, wherein the host group with less hosts to update can be selected ahead of host groups with more hosts to update.

In some implementations, when a host group is identified to update, update service 120 may determine whether the update requires the host to be powered down or otherwise become unavailable. If the update does not require the host to be unavailable, each of the hosts can be updated without waiting for information from the resource scheduling service. In some implementations, update service 120 may also determine whether the virtual machines on a host can be powered down or be made unavailable based on a quality-of-service requirement (service level agreement) associated with the virtual machines. If they can be powered down or made unavailable, the host can be updated without the information from the resource scheduling service. For example, if virtual machines 130 on host 110 can be made unavailable, update service 120 may update host 110 without migrating the virtual machines.

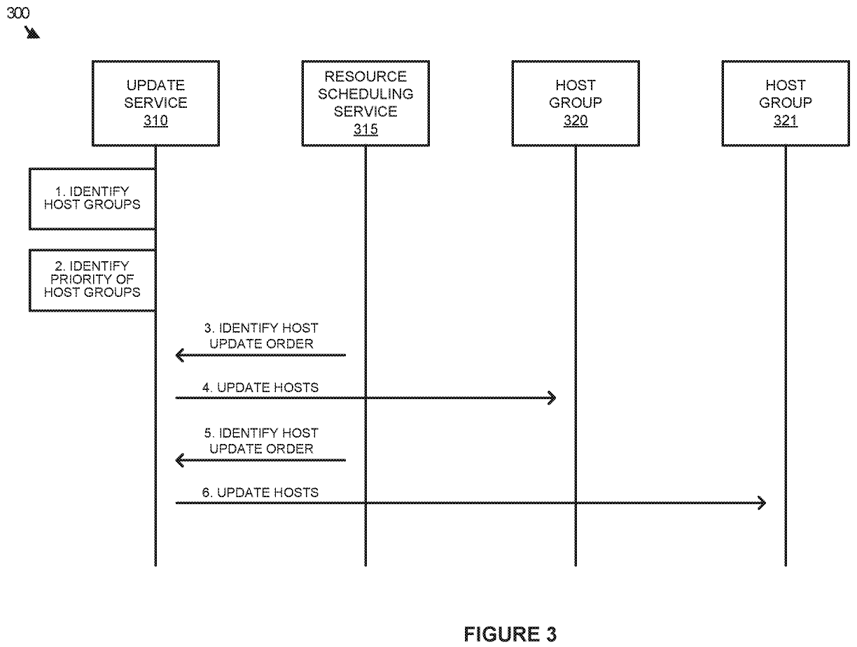

FIG. 3 illustrates a timing diagram 300 for updating multiple host groups according to an implementation. Timing diagram 300 includes update service 310, resource scheduling service 315, and host group 320-321.

In timing diagram 300 and in response to a request to update hosts in a computing environment, update service 310 identifies, at step 1, host groups in the computing environment that each include one or more hosts that require an update. Each of the host groups may comprise fault domains that can be distributed across one or more data centers. After the host groups are identified, update service 310 prioritizes the host groups to determine an order for updating each of the host groups at step 2. The prioritization may be based on the data center for the host group, may be based on the number of hosts required to be updated in each of the host groups, or may be based on some other factor. For example, host group 320 may represent a primary host group and host group 321 may represent a secondary host group, which can be dictated by the administrator of the computing environment. Accordingly, if host group 320 were indicated to be the primary host group, update service 310 may prioritize the update of host group 320 over host group 321.

After prioritizing the host groups, update service 310 identifies an update order for the hosts using information resource scheduling service 315 at step 3. Resource scheduling service 315 is used to provide resources to virtual machines executing on the hosts in the host group, wherein the resources may include processing resources, memory resources, networking resources, and the like. Resource scheduling service may identify hosts without virtual machines that are capable of being updated, hosts with virtual machines that can be powered down during the update process, migrate virtual machines between hosts to make a host available to be updated, or provide some other operation. In some examples, resource scheduling service 315 may maintain a quality of service for the virtual machines and may indicate one or more hosts that are available to be updated while maintaining the quality of service for the virtual machines. Thus, a host group may include ten hosts, but resource scheduling service 315 may only permit two of the hosts to be updated at a time. Once the information is obtained from resource scheduling service 314, update service 310 updates the hosts in host group 320 at step 4.

In some examples, update service 310 may identify one or more first hosts to update based on information from resource scheduling service 315. Once updated, update service 310 may identify one or more additional hosts in host group 320 to update and may repeat the update process as required until all the hosts in host group 320 are updated. Referring to the previous example, resource scheduling service 315 may indicate two hosts at a time to be updated. Once all the hosts are updated, update service 310 may move to updating another host group.

Here, after completing the update of the hosts of host group 320, update service 310 selects another host group 321 and identifies a host update order using resource scheduling service 315 at step 5. In some examples, resource scheduling service 315 may provide identifiers for hosts that are available to be updated. From the identifying information, update service 310 may initiate the update of the hosts at step 6. Once an update is completed for one or more first hosts in host group 321, update service 310 may determine whether any hosts in host group 321 still require the update. Update service 310 may identify one or more additional hosts to update based on the information from resource scheduling service 315 and initiate the update to the one or more additional hosts. The process can be repeated as necessary to update each of the hosts in the host group.

In some implementations, the update to the hosts may not require the hosts to be powered down or to become unavailable. In these examples, update service 310 may update the hosts in the host group without using resource scheduling service 315. In some implementations, hosts in a host group may execute virtual machines that can be powered off or made unavailable during a required update. This may be configured by an administrator that indicates that quality of service or service level agreement associated with the virtual machines. In these examples, the hosts may also be updated without the use of resource scheduling service 315.

Although demonstrated with two host groups in the example of timing diagram 300, computing environments may use any number of host groups to provide a platform for the virtual workloads. Further, while demonstrated as each host group requiring updates, some host groups may not include hosts that were previously updated, or a user may request that a subset of host groups be updated. For example, an administrator may request that only hosts that are part of a primary host group be updated, while hosts that are part of a secondary host group not be updated. Advantageously, an administrator may update a first host group, determine whether the update was successful, and subsequently update one or more other host groups

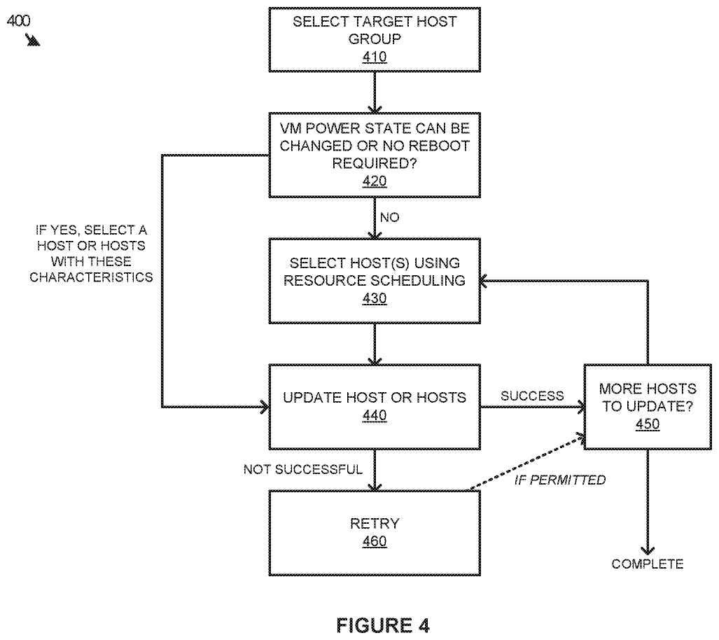

FIG. 4 illustrates an operational scenario 400 of updating hosts within a host group according to an implementation. The steps in operational scenario 400 will be referenced parenthetically in the paragraphs that follow.

In operational scenario 400, an update service may select (410) a target host group from a set of host groups in a computing environment. In some implementations, the host group can be selected using a prioritization, wherein the host groups can be prioritized based on administrator settings (e.g., a primary host group, secondary host group, and the like), can be prioritized based on the number of hosts that are required to be updated in the host group, or based on some other factor. Each of the host groups may include one or more hosts that belong to the host group based on an identifier allocated by the administrator of the computing environment. For example, an administrator may define a first host group for hosts that are on a first rack and may define a second host group for hosts that are on a second rack. The administrator may then define a prioritization for the host groups to be updated or may permit the update service to prioritize the host groups for updating based on the number of hosts in the host group to be updated.

Once the host group is selected, the update service may determine (420) whether the virtual machine power state can be changed on a host or whether a reboot is required to perform the update. If the virtual machine state can be changed for the hosts or no reboot is required for the hosts, then the hosts can be updated (440) for the host group. The updating of the hosts may be performed in parallel or may be performed sequentially. For example, an update may not require the hosts in a host group to be rebooted to implement the update. Accordingly, the update service may initiate the updates to the hosts of the host group without updating hosts based on resource scheduling.

If the state of the virtual machines cannot be changed or a reboot is required for the hosts to implement the update, the update service further identifies (430) one or more hosts to update using at least resource scheduling information. In some implementations, the resource scheduling information may be obtained from a resource scheduler that is used provide virtual machines with required resources. The resources may comprise processing resources, memory resources, networking resources, or some other resources. In some examples, the resources may be provided based on a quality of service associated with the virtual machine, wherein minimum or required resources may be assigned to the virtual machines. While ensuring that the virtual machines are provided the required resources (or a minimum number of virtual machines are available), the resource scheduler may indicate one or more hosts that are available to be updated. The resource scheduler may migrate virtual machines, stop the execution of the virtual machines, or provide some other operation to make at least one host available for the update. Once available, the resource scheduler may provide an identifier for the one or more hosts available to be updated. After selection, the update service initiates (440) the update of the one or more hosts.

If the update is not successful, operational scenario 400 may move to retry (460) the update to the one or more hosts. In some implementations, the update service may determine whether a retry should occur for the one or more hosts, wherein some update failures may trigger a failure for the update to the computing environment. Failures that prevent a retry of the update may include power loss, connectivity issues in association with the host, or some other issue that prevents retrying the update to the host. In some examples, the update service may retry the update a limited number of times before the update is failed. In some examples, the retry of the update may occur immediately following the failed update attempt, however, in retrying the update, the host may be added back to the pool of hosts in the host group to update. If the retry operation is permitted, the update service may move to step 450 to determine whether one or more hosts require the update.

In examples where the update was successful for the one or more hosts, operational scenario also moves to step 450 to determine whether one or more hosts remain in the host group to be updated. If no hosts remain, the update for the host group is complete and the update service may identify another host group to update if another host group remains. If one or more hosts remain, the update service returns to identifying (430) one or more hosts to be updated using the resource scheduling information associated with the host group.

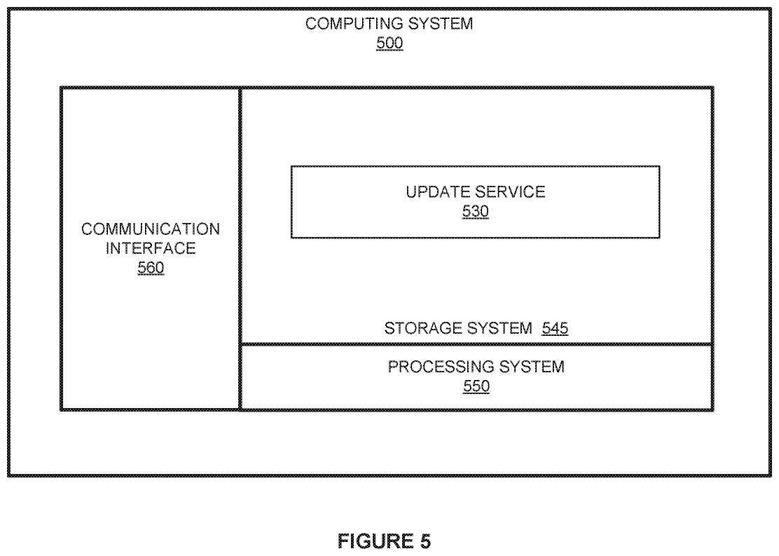

FIG. 5 illustrates a computing system 500 with an update service to manage the update of hosts in a computing environment according to an implementation. Computing system 500 is representative of any computing system or systems with which the various operational architectures, processes, scenarios, and sequences disclosed herein for an update service can be implemented. Computing system 500 is an example of update service 150 of FIG. 1, although other examples may exist. Computing system 500 includes storage system 545, processing system 550, and communication interface 560. Processing system 550 is operatively linked to communication interface 560 and storage system 545. Computing system 500 may further include other components such as a battery and enclosure that are not shown for clarity.

Communication interface 560 comprises components that communicate over communication links, such as network cards, ports, radio frequency (RF), processing circuitry and software, or some other communication devices. Communication interface 560 may be configured to communicate over metallic, wireless, or optical links. Communication interface 560 may be configured to use Time Division Multiplex (TDM), Internet Protocol (IP), Ethernet, optical networking, wireless protocols, communication signaling, or some other communication format—including combinations thereof. Communication interface 560 may be configured to communicate with one or more hosts in a computing environment, wherein the communications may be used to trigger the update of the one or more hosts. Additionally, communication interface 560 may be used to obtain resource scheduling information indicative of hosts available to be updated or some other information related to the scheduling of workloads in the computing environment.

Processing system 550 comprises microprocessor and other circuitry that retrieves and executes operating software from storage system 545. Storage system 545 may include volatile and nonvolatile, removable and non-removable media implemented in any method or technology for storage of information, such as computer readable instructions, data structures, program modules, or other data. Storage system 545 may be implemented as a single storage device but may also be implemented across multiple storage devices or sub-systems. Storage system 545 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 550 is typically mounted on a circuit board that may also hold the storage system. The operating software of storage systems 545 comprises computer programs, firmware, or some other form of machine-readable program instructions. The operating software of storage system 545 comprises update service 530. The operating software on storage system 545 may further include utilities, drivers, network interfaces, applications, or some other type of software. When read and executed by processing system 550 the operating software on storage system 545 directs computing system 500 to operate as described herein. In some implementations, maintain operation 515 may provide at least operation 200 described in FIG. 2.

In at least one implementation, update service 530 directs processing system 550 to identify a request to update a plurality of hosts in a computing environment. The updates may be used to provide additional features in the platform supporting workloads in the computing environment, fix issues associated with the platform, or provide some other update. In response to the request, update service 530 directs processing system 550 to identify host groups in a computing environment to be updated, wherein each of the host groups comprises one or more hosts of the plurality of hosts. The host groups may be defined by an administrator in some examples and could be chassis based, rack based, computing site based, or some other division of the groups. Once the host groups are identified, update service 530 directs processing system 550 to prioritize the host groups for updates based at least on a quantity of hosts not updated in each of the host groups. The host groups may be prioritized based on administrator preferences, based on the number of hosts in each of the groups that require the update, or based on some other factor. After the host groups are prioritized, update service 530 directs processing system 550 to select a group in the host groups based on the prioritization, wherein the selected host group comprises the group with the highest priority.

After selecting a host group, update service 530 directs processing system 550 to identify one or more hosts from the host group to be updated based at least on resource scheduling information and update the one or more hosts. In some examples, the resource scheduling information may be provided by a resource scheduler that provides the required resources to different workloads. The resource scheduler may provide the required processing, memory, networking, and other resources to each of the workloads based on a quality of service required for each of the workloads. Once the hosts are updated, update service 530 can remove the hosts from the host group to be updated and repeat the operations of identifying hosts in the host group to be updated so long as more additional hosts require an update. If no more hosts exist in the group to be updated, then update service 530 may move to the next prioritized group (if one exists) and implement the same operations to update hosts in that group. The update operations are complete when all the host groups have been updated.

In some implementations, at least a portion of the updates may fail in association with the hosts. In examples where an update fails, update service 530 may retry the update, if possible, to fix the update of the host. If retrying the update is not possible, the update may fail and a notification may be provided to an administrator associated with the update, wherein the notification may comprise a text, a popup notification, an email, or the like. If retrying the update is possible, update service 530 may attempt to apply the update for a period and, if the update fails, end the update attempt and notifying the administrator of the failure.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
(a) identifying a request to update a plurality of hosts in a computing environment;
(b) in response to the request, identifying host groups in a computing environment to be updated, wherein each of the host groups comprises one or more hosts of the plurality of hosts;
(c) prioritizing the host groups for updates based at least on a quantity of hosts not updated in each of the host groups;
(d) selecting a group in the host groups for updating based on the prioritization of the host groups;
(e) for the selected host group;
(i) identifying one or more hosts from the host group to be updated based at least on resource scheduling information;
(ii) updating the one or more hosts;
(iii) removing the one or more hosts from the host group to be updated;
(iv) repeating steps (i)-(iii) when at least one host remains in the host group to be updated;
(f) repeating step (e) for a next host group in the host groups based on the prioritization when at least one host group has not been updated using step (e).

2. The method of claim 1, wherein selecting the one or more hosts from the host group to be updated based at least on the resource scheduling is further based on a minimum quality of service associated with workloads in the host group.

3. The method of claim 2, wherein the workloads comprise virtual machines.

4. The method of claim 1, wherein identifying the host groups comprises identifying host groups based on fault domains, wherein the fault domains comprise a group of hosts that share a single point of failure.

5. The method of claim 1, wherein identifying the host groups comprises identifying a preferred site host group and a secondary site host group.

6. The method of claim 5, wherein prioritizing the host groups for updates based at least on a quantity of hosts not updated in each of the host groups is further based on whether the host groups comprise a preferred site host group or a secondary site host group.

7. The method of claim 1, wherein identifying the host groups in the computing environment to be updated comprises identifying host group identifiers associated with each host in the plurality of hosts.

8. A computing apparatus comprising:
a storage system;
a processing system operatively coupled to the storage system;
program instructions stored on the storage system that, when executed by the processing system, direct the computing apparatus to:
(a) identify a request to update a plurality of hosts in a computing environment;
(b) in response to the request, identify host groups in a computing environment to be updated, wherein each of the host groups comprises one or more hosts of the plurality of hosts;
(c) prioritize the host groups for updates based at least on a quantity of hosts not updated in each of the host groups;
(d) select a group in the host groups for updating based on the prioritization of the host groups;
(e) for the selected host group;
(i) identify one or more hosts from the host group to be updated based at least on resource scheduling information;
(ii) update the one or more hosts;
(iii) remove the one or more hosts from the host group to be updated;
(iv) repeat steps (i)-(iii) when at least one host remains in the host group to be updated;
(f) repeat step (e) for a next host group in the host groups based on the prioritization when at least one host group has not been updated using step (e).

9. The computing apparatus of claim 8, wherein selecting the one or more hosts from the host group to be updated based at least on the resource scheduling is further based on a minimum quality of service associated with workloads in the host group.

10. The computing apparatus of claim 9, wherein the workloads comprise virtual machines.

11. The computing apparatus of claim 8, wherein identifying the host groups comprises identifying host groups based on fault domains, wherein the fault domains comprise a group of hosts that share a single point of failure.

12. The computing apparatus of claim 8, wherein identifying the host groups comprises identifying a preferred site host group and a secondary site host group.

13. The computing apparatus of claim 12, wherein prioritizing the host groups for updates based at least on a quantity of hosts not updated in each of the host groups is further based on whether the host groups comprise a preferred site host group or a secondary site host group.

14. The computing apparatus of claim 8, wherein identifying the host groups in the computing environment to be updated comprises identifying host group identifiers associated with each host in the plurality of hosts.

15. A system comprising:
a plurality of hosts;
an update service computing system communicatively coupled to the hosts and configured to:
(a) identify a request to update a plurality of hosts in a computing environment;
(b) in response to the request, identify host groups in a computing environment to be updated, wherein each of the host groups comprises one or more hosts of the plurality of hosts;
(c) prioritize the host groups for updates based at least on a quantity of hosts not updated in each of the host groups;
(d) select a group in the host groups for updating based on the prioritization of the host groups;
(e) for the selected host group;
(i) identify one or more hosts from the host group to be updated based at least on resource scheduling information;
(ii) update the one or more hosts;
(iii) remove the one or more hosts from the host group to be updated;
(iv) repeat steps (i)-(iii) when at least one host remains in the host group to be updated;
(f) repeat step (e) for a next host group in the host groups based on the prioritization when at least one host group has not been updated using step (e).

16. The system of claim 15, wherein selecting the one or more hosts from the host group to be updated based at least on the resource scheduling is further based on a minimum quality of service associated with workloads in the host group.

17. The system of claim 16, wherein the workloads comprise virtual machines.

18. The system of claim 15, wherein identifying the host groups comprises identifying host groups based on fault domains, wherein the fault domains comprise a group of hosts that share a single point of failure.

19. The system of claim 15, wherein identifying the host groups comprises identifying a preferred site host group and a secondary site host group.

20. The system of claim 19, wherein prioritizing the host groups for updates based at least on a quantity of hosts not updated in each of the host groups is further based on whether the host groups comprise a preferred site host group or a secondary site host group.
